(19) United States
(12) Patent Application Publication
(10) Pub. No.: US 2009/0211656 A1
(43) Pub. Date: Aug. 27, 2009

(54) Changeover unit for fuel gas pressure reducer

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/071,425

(22) Filed: Feb. 21, 2008

(51) Int. Cl. G05D 16/00; F16K 11/00

(52) U.S. Cl. 137/625.46

(57) ABSTRACT

The creation discloses a changeover unit for a fuel gas pressure reducer comprising at least two pressure reducers applicable for various kinds of fuel gases, and a changeover valve for connecting a gas source to the pressure reducers. Said changeover valve further comprises a valve body accommodating groove, and a valve core mounted within the valve body accommodating groove. The pressure reducers for various kinds of fuel gases are connected by the valve body accommodating groove of the changeover valve, and are applicable for at least two or more kinds of fuel gases by switching the valve core. Users can adjust or change the pressure reducer which matches the kind of fuel gas by themselves in accordance with the kind of fuel gas.

### BACKGROUND OF THE INVENTION

(a) Field of the Invention

The creation relates to a changeover unit for a fuel gas pressure reducer, and, more particularly, to a changeover unit for a fuel gas pressure reducer, which can be changed by users themselves in accordance with the kind of fuel gas to match the fuel gas; particularly applicable for the changeover between natural gas and liquefied petroleum gas (packaged gas).

(b) Description of the Prior Art:

The presently commercially used fuel gases are divided into natural gas and packaged liquefied petroleum gas (commonly referred to as packaged gas). Because these two kinds of fuel gases have different pressures during transportation and use, in general, it is necessary to decompress them through the pressure reducers before entering the burners for combustion. However, various kinds of fuel gases are different in pressure during transportation and use so that the pressure reducers in burners such as a tabletop cooking device, a gas water heater, or the like. When purchasing a pressure reducer, it is necessary to select the pressure reducer in accordance with the kind of the combustion gas for the corresponding arrangement thereof.

At the present day, any pressure reducer has a single function, that is, one pressure reducer can only decompress a specific fuel gas. The natural gas consumers must use the pressure reducers for pipeline natural gas to obtain the pressure used in the burners; and the liquefied petroleum gas (packaged gas) consumers must use the pressure reducers for liquefied petroleum gas to the working pressure required by the burners. Accordingly, the burner makers need to arrange different pressure reducers with respect to the fuel gas species in a sales territory. This causes great inconvenience for the manufacturers, dealers and users.

### SUMMARY OF THE INVENTION

The creation that has been made to solve the technical problems in view of the present technical situation is to provide a changeover unit for a fuel gas pressure reducer, which can be switched by users themselves in accordance with the kind of fuel gas to match the kind of fuel gas.

In order to solve the above technical problems, the changeover unit of the creation comprises: at least two pressure reducers applicable for various kinds of fuel gases, and a changeover valve for connecting a gas source to the pressure reducers; wherein the changeover valve further comprises a valve body accommodating groove and a valve core which is mounted within the valve body accommodating groove; said valve body accommodating groove is provided thereon with at least two passages independent of one another, each of which is respectively connected to the corresponding pressure reducer. When the changeover unit is in use, the valve core is turned so as to enable various fuel gases to enter their matching passages and pressure reducers, and then the fuel gases are decompressed through the pressure reducers for use.

In general circumstances, two kinds of fuel gases are commonly used, i.e. natural gas and liquefied petroleum gas. Therefore, two of said pressure reducers could be selected, which are a natural gas pressure reducer and a liquefied petroleum gas pressure reducer respectively; there are also two passages which match the above pressure reducers. If three or more kinds of fuel gases are commonly used in some regions or countries, the number of the passages disposed in the pressure reducers and the valve body accommodating groove can depend on the local conditions.

Said passages can be disposed in the same horizontal plane, and said valve body accommodating groove and pressure reducers can also be disposed in the same horizontal plane. Furthermore, a gas hole, which passes through the valve core, is disposed at the position on said valve core corresponding to the passage. The fuel gas is transferred to the passage through the gas hole.

In the implementation of the creation, said valve body accommodating groove can be a barrel-shaped shell, and said passage is disposed on the barrel wall. The valve core is a plunger which matches said barrel-shaped valve body accommodating groove, said plunger can be provided thereon with a tooling hole in favor of inserting the tool thereinto to turn the valve core. The shape of said tooling hole matches the used tool, for example, the tooling hole is “straight” when a straight head screwdriver is used, and the tooling hole is “cross” when a crosshead screwdriver is used, and the tooling hole can be a hexagonal hole when a spanner is used. Namely, it is simple for general users to switch by using the tooling hole, and it is very easy in use.

When users turn the valve core so as to align the gas hole thereon to one passage, the other passage is blocked and vice versa. In the implementation of the creation, the longitudinal section of said valve core is suitably “T” shaped, the upper end portion of which is cylindrical and the lower end portion of which is plate-like. The gas hole is disposed at the lower portion of the plate-like valve core such that the fuel gas can pass through the changeover valve and then enter the pressure reducer more smoothly.

Said pressure reducers and changeover valve are mounted within a casing, the rear end of which has a gas inlet pipe for connecting the changeover valve to a gas source and the front end of which has a gas outlet pipe for connecting the pressure reducer to a combustion equipment.

Said casing is provided therein with pressure reducer accommodating grooves which match the pressure reducers and are independent of each other; said pressure reducer accommodating grooves correspond to the gas inlet and outlet positions of the pressure reducers and are respectively provided with a gas inlet hole and a gas outlet hole.

In the implementation of the creation, said pressure reducer accommodating grooves and said changeover valve are arranged in a straight line; and the foregoing casing is partitioned into a left chamber and a right chamber independent of each other by the valve body accommodating groove together with the pressure reducer accommodating grooves; the gas inlet and outlet holes are disposed on the top of the gas outlet pipe; one passage in the valve body accommodating groove is directly connected to the gas inlet hole of the adjacent pressure reducer accommodating groove, and the gas outlet hole of the pressure reducer communicates with the left chamber of the casing, and the other passage in the valve body accommodating groove and the gas inlet hole of the other pressure reducer accommodating groove communicate with the right chamber of the casing, and the gas outlet hole of the other pressure reducer is directly connected to the gas outlet pipe of the casing. In the embodiment, the pressure reducer accommodating grooves are designed to link up with the valve body accommodating groove and to partition the casing into the left chamber and the right chamber independent of each other so as to form a fuel gas passage.

A natural gas pressure reducer can be disposed in said pressure reducer accommodating groove adjacent to the valve body accommodating groove, and a liquefied petroleum gas pressure reducer is disposed in the other pressure reducer accommodating groove.

Compared with the prior art, a changeover valve is adopted to link up with the pressure reducers applicable for various kinds of fuel gases according to the creation. Besides, the method for adjusting the changeover valve is simple and convenient such that users can adjust or change the pressure reducer which matches the kind of fuel gas by themselves in accordance with the kind of fuel gas. Moreover, it is more convenient for the fuel gas pressure reducer manufacturers and dealers to manage, and unnecessary to particularly arrange or change a different pressure reducer due to a different sales territory or a different kind of fuel gas, thereby significantly reducing the marketing and manufacturing costs.

### BRIEF DESCRIPTION OF THE DRAWINGS

The creation will become apparent from the following detailed description of the preferred embodiment taken in conjunction with the accompanying drawings.

FIG. 1 is a three dimensional view of an embodiment of the creation.

FIG. 2 is a schematic view showing a valve core of the creation.

FIG. 3 is a schematic view showing the flowing path of natural gas when a changeover valve is switched to the natural gas position according to the creation.

FIG. 4 is a schematic view showing the flowing path of liquefied petroleum gas when a changeover valve is switched to the liquefied petroleum gas position according to the creation.

FIG. 5 is a side sectional view of the creation.

FIG. 6 is a side sectional view of showing another side with respect to FIG. 5 according to the creation.

FIG. 7 is a schematic view showing the natural gas position to which the valve core is shifted according to the creation.

FIG. 8 is a schematic view showing the liquefied petroleum gas position to which the valve core is shifted according to the creation.

### DETAILED DESCRIPTION OF THE PREFERRED EMBODIMENTS

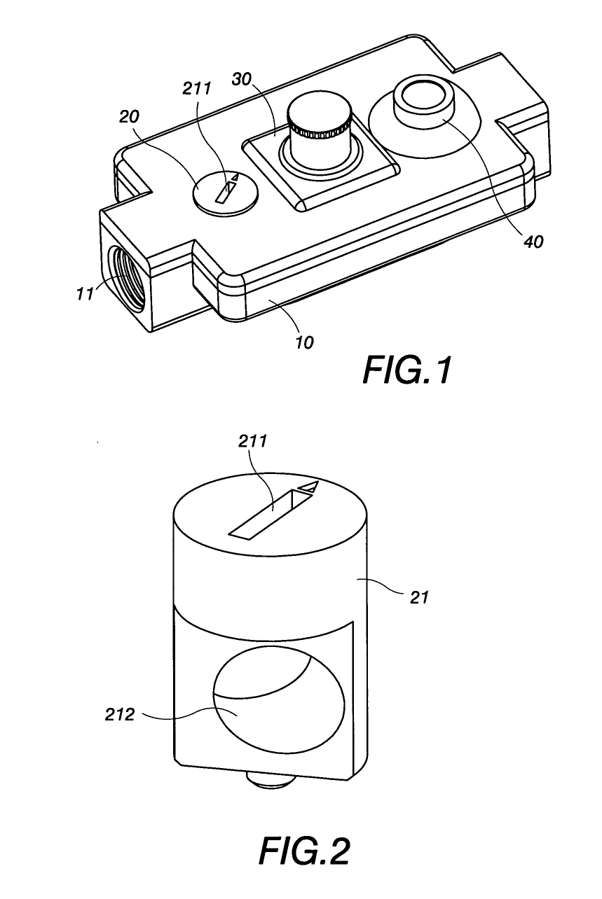

As illustrated in FIG. 1, a changeover unit for a fuel gas pressure reducer according to the creation comprises a casing 10, a changeover valve 20 which is disposed in the casing 10 and in turn arranged in a straight line, and a natural gas pressure reducer 30 and a liquefied petroleum gas pressure reducer 40.

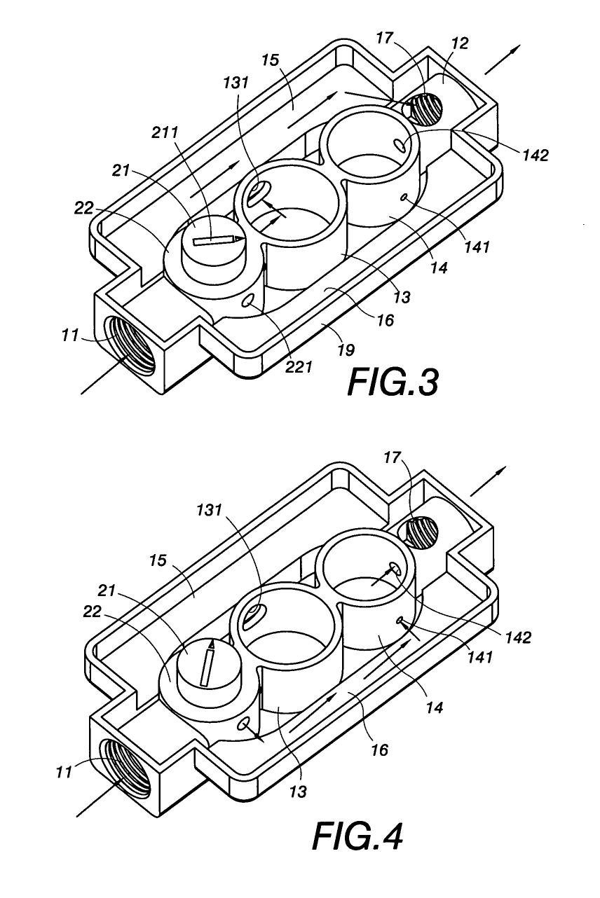

As illustrated in FIGS. 3 and 4, the foregoing casing 10 can be used in several forms: uniform geometry such as circular shapes, ellipse shapes, triangular shapes, or random geometry. In this embodiment as disclosed in the drawings, the casing 10 is rectangular shape; the rear end of which has a gas inlet pipe 11 for connecting a gas source to the changeover valve 20 and the front end of which has a gas outlet pipe 12 for connecting the liquefied petroleum gas pressure reducer 40 to a combustion equipment, and a gas inlet hole 17 is disposed on the top of the gas outlet pipe 12, which passes through the upper wall of the gas outlet pipe 12.

On the inner bottom surface of the above casing 10, a base 19 is provided. A circular valve body accommodating groove 22, a first pressure reducer accommodating groove 13 and a second pressure reducer accommodating groove 14 for respectively accommodating the valve core 21 of the changeover valve 20, the natural gas pressure reducer 30 and the liquefied petroleum gas pressure reducer 40 are disposed on the base 19. According to the creation, the shapes of the circular valve body accommodating groove 22, the first pressure reducer accommodating groove 13 and the second pressure reducer accommodating groove 14 are not limited to circular shapes as long as they can match the shapes of the valve core 21, the natural gas pressure reducer 30 and the liquefied petroleum gas pressure reducer 40 respectively, and they can be changed in accordance with the actual circumstances.

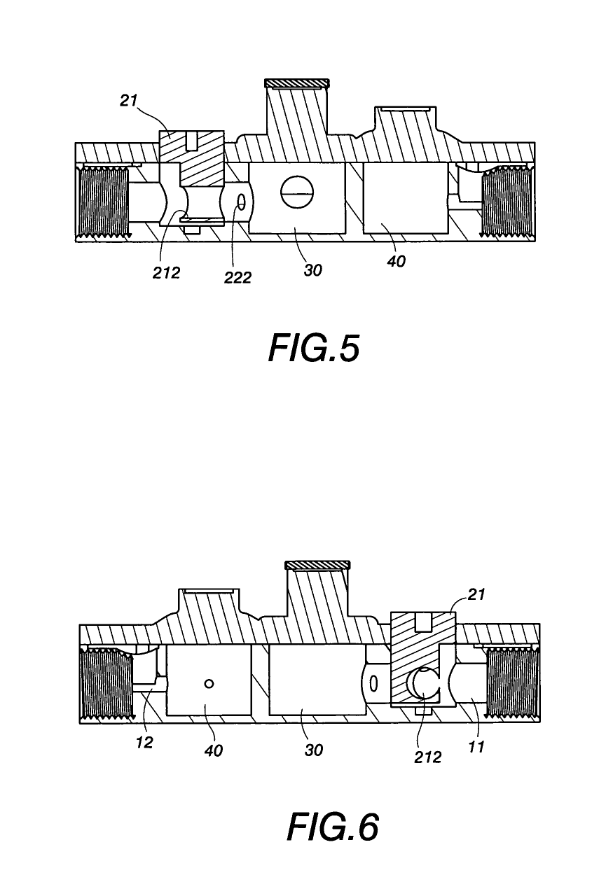

The inner cavity of the casing 10 is partitioned into two of a left chamber 15 and a right chamber 16 independent of each other by said valve body accommodating groove 22 together with the first pressure reducer accommodating groove 13 and the second pressure reducer accommodating groove 14. On the cross-connecting walls between said valve body accommodating groove 22 and said first pressure reducer accommodating groove 13, a natural gas passage 222 is provided. As illustrated in FIG. 5, the natural gas passage 222 serves as both the gas outlet of the changeover valve 20 and the gas inlet of the natural gas pressure reducer 30. A liquefied petroleum gas passage 221 is provided on the right side wall of the valve body accommodating groove 22; a natural gas outlet hole 131 is disposed on the left side wall of said first pressure reducer accommodating groove 13; a gas inlet hole 141 is disposed on the right side wall of said second pressure reducer accommodating groove 14, the front end of which is provided with a liquefied petroleum gas outlet hole 142 corresponding to the gas outlet pipe 12.

As illustrated in FIGS. 1, 3 and 4, the foregoing changeover valve 20 is composed of a knob-type valve core 21 which can be turned in the valve body accommodating groove 22. As illustrated in FIG. 2, the upper portion of the valve core 21 is a cylindrical shape, which matches the valve body accommodating groove 22, and its lower portion is plate-like with a “T” shaped longitudinal section. The upper end surface of the valve core 21 is provided thereon with a tooling hole 211, in the drawing, the tooling hole 211 is a “straight” groove in favor of turning the valve core 21 using a straight head screwdriver. The plate-like lower portion is provided with a gas through hole 212.

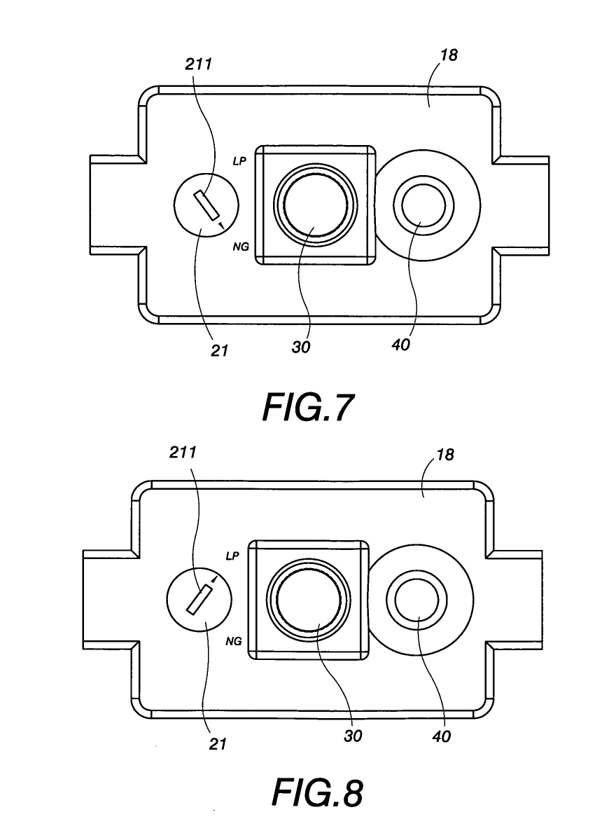

As illustrated in FIGS. 3 to 7, said casing 10 includes a top cover 18 and the base 19. The positions on the top cover 18 corresponding to the natural gas passage 222 and the liquefied petroleum gas passage 221 are provided with markers for NG (natural gas) and LP (liquefied petroleum gas) for the convenience of users recognizing the turning angle of the valve core 21.

As illustrated in FIGS. 1, 3 and 5, the natural gas pressure reducer 30 and the liquefied petroleum gas pressure reducer 40 are correspondingly mounted in the first pressure reducer accommodating groove 13 and the second pressure reducer accommodating groove 14 within the casing 10. When it is desired to use natural gas, the valve core 21 is turned to the NG (natural gas) position via the tooling hole 211 by using a screwdriver. At this time, the gas hole 212 on the valve core 21 is aligned to the natural gas passage 222, and natural gas passes through the gas hole 212, the natural gas passage 222, entering the natural gas pressure reducer 30, followed by decompression, exiting from the gas outlet hole 131 and entering the left chamber 15, then entering the gas outlet pipe 12 through the gas inlet hole 17, reaching the natural gas burner to satisfy the service condition. The flowing path of natural gas is along the direction shown as the arrowhead in FIG. 3.

As illustrated in FIGS. 1, 4 and 6, the tooling hole 211 is moved to the LP (liquefied petroleum gas) position. At this time, the gas hole 212 on the valve core 21 is aligned to the liquefied petroleum gas passage 221, and liquefied petroleum gas passes through the gas hole 212, the liquefied petroleum gas passage 221, entering the right chamber 16, then entering the liquefied petroleum gas pressure reducer 40 from the gas inlet hole 141, followed by decompression, entering the gas outlet pipe 12 from the gas outlet hole 142 and reaching the liquefied petroleum gas burner to satisfy the service condition. The flowing path of liquefied petroleum gas is along the direction shown as the arrowhead in FIG. 4.

What has been described above is the preferred embodiment of the creation only, and it is not intended to limit the scope of the creation. Various equivalent changes and alternatives to the creation can be made to the elements of the creation without departing from the spirit and scope of this creation. Accordingly, all such equivalent changes and alternatives should be included within the scope of the appended claims.

I claim,

1. A changeover unit for a fuel gas pressure reducer comprising at least two pressure reducers applicable for various kinds of fuel gases, which are provided in a casing, and a changeover valve for connecting a gas source to the pressure reducers, wherein the changeover valve further comprises a valve body accommodating groove which is provided within the casing, and a valve core which is mounted within the valve body accommodating groove, and said valve body accommodating groove is provided thereon with at least two passages corresponding to the number of pressure reducers and independent of one another, each of which is respectively connected to the corresponding pressure reducer and controls the on/off of the two passages via the valve core.

2. The changeover unit for a fuel gas pressure reducer as described in claim 1, wherein: said at least two pressure reducers are a natural gas pressure reducer and a liquefied petroleum gas pressure reducer respectively.

3. The changeover unit for a fuel gas pressure reducer as described in claim 1, wherein: a gas through hole is disposed at the position on said valve core corresponding to the passage.

4. The changeover unit for a fuel gas pressure reducer as described in claim 1, wherein: said pressure reducers and changeover valve are mounted within the casing, the rear end of which has a gas inlet pipe for connecting the changeover valve to a gas source and the front end of which has a gas outlet pipe for connecting the pressure reducer to a combustion equipment.

5. The changeover unit for a fuel gas pressure reducer as described in claim 4, wherein: said casing is provided therein with a first pressure reducer accommodating groove and a second pressure reducer accommodating groove, which match the two pressure reducers and are independent of each other; said first pressure reducer accommodating groove and said second pressure reducer accommodating groove correspond to the gas inlet and outlet positions of the pressure reducers and are respectively provided with a gas inlet hole and a gas outlet hole.

6. The changeover unit for a fuel gas pressure reducer as described in claim 5, wherein: said first pressure reducer accommodating groove, said second pressure reducer accommodating groove and the changeover valve are arranged in a straight line, and said casing is partitioned into a left chamber and a right chamber independent of each other by the valve body accommodating groove together with the first pressure reducer accommodating groove and the second pressure reducer accommodating groove; the gas inlet and outlet holes are disposed on the top of said gas outlet pipe; one passage in said valve body accommodating groove is directly connected to the gas inlet hole of the adjacent first pressure reducer accommodating groove such that the gas outlet hole of said pressure reducer communicates with the left chamber of the casing, and the other passage in the valve body accommodating groove and the gas inlet hole of the second pressure reducer accommodating groove communicate with the right chamber of the casing so as to directly connect the gas outlet hole of the other pressure reducer with the gas outlet pipe of the casing.

7. The changeover unit for a fuel gas pressure reducer as described in claim 6, wherein: the natural gas pressure reducer is disposed in said first pressure reducer accommodating groove adjacent to the valve body accommodating groove, and the liquefied petroleum gas pressure reducer is disposed in the second pressure reducer accommodating groove.
